(19) United States
(12) Patent Application Publication
(10) Pub. No.: US 2012/0159574 A1
(43) Pub. Date: Jun. 21, 2012

(54) METHOD AND SYSTEM FOR PROVIDING INFORMATION SHARING SERVICE FOR NETWORK ATTACKS

(75) Inventor: Il Ahn CHEONG, Daejeon (KR)

(73) Assignee: Electronics and Telecommunications Research Institute, Daejeon (KR)

(21) Appl. No.: 13/332,125

(22) Filed: Dec. 20, 2011

(30) Foreign Application Priority Data
Dec. 20, 2010 (KR) 10-2010-0130874

(51) Int. Cl. G06F 21/00; G06F 15/16

(52) U.S. Cl. 726/3; 726/22

(57) ABSTRACT

A system is provided to provide an information sharing service for network attacks. The system includes a service provider configured to collect and analyse information on detection and response policies to network attacks, a service registry that stores the collected information on the detection and response policies, and client terminals, each client terminal configured to request the information sharing service and search the service registry for the information on the detection and response policies.

### CROSS-REFERENCE(S) TO RELATED APPLICATION(S)

The present invention claims priority of Korean Patent Application No. 10-2010-0130874, filed on Dec. 20, 2010, which is incorporated herein by reference.

### FIELD OF THE INVENTION

The present invention relates to a technology for detection and response of network attacks, and more particularly, to a system and method for providing an information sharing service for network attacks between a service provider and service users.

### BACKGROUND OF THE INVENTION

As damages from internet disturbance was known since Jan. 25, 2002 and a distributed denial of service (DDoS) attack targeted for main sites was generated on Jul. 7, 2009, it was an opportunity that seriousness on security risk to the world countries has increased.

Recently, continuous and indiscriminate DDoS attacks, targeted for various types of web sites such as a game portal or financial service, a shopping mall, a stock service, and the like, result in an increase in economically and socially damaged range and damaged amount.

These attacks have intention of a pecuniary advantage, illegal circulation of hazardous information, infringement of copyright, or terror aimed at social public goods, and takes on an aspect of more intelligent and systematic attack. A malicious bot rendering a PC to be zombie to perform a DDoS attack has increasingly become high technical, and the case of use of an attack tool automated to allow for a mass production of such a malicious code have occurred. Further, several instances in which a high level of reverse engineering and analysis interfering technology for enhancing a success rate and survival ability in the attack are combined have been found. It has been reported that a number of mobile malicious codes were found overseas, and also domestically, as a smart phone having an open mobile operating system mounted thereon is vitalized in use, a possibility in which mobile malicious codes will occur is more increased.

Furthermore, several DDoS attacks occur from enterprises that provide a social network service for sharing and communicating information between acquaintances and anonymous internet users.

An existing defense technology against a DDoS attack is merely a small scale of a local response only for networks occuring the DDoS attack, which may not be an efficient and active response to an extensive DDoS attack to be undertaken. This DDoS attack may cause serious damages on an attack target site as well as an internet data center (IDC)/internet service provider (ISP) environment connected to the DDoS target site.

Enterprises managing many servers such as Internet portals or online game companies have a difficulty in perfectly realizing security by using only conventional network security products, and it is difficult to establish a fire wall to large capacity network traffic. Also, enormous damages may be caused by weakness in a single server in spite of thorough management on the servers.

Thus, the research institutions and security solution enterprises have developed various response technologies in order to effectively respond to DDoS attacks.

However, these DDoS response technologies are managed by each security solution enterprise itself, and mutual exchange and sharing of information between security solution companies are substantially restricted. In addition, there is a limit for a cyber attack response center managed in a centralized manner to respond to internet attacks at the national level, to establish a policy for collecting and analyzing many events and responding to DDoS attacks, which may becomes one of factors in making a rapid response difficult. This mutual sharing limitation with information on the attack detection and response policy contributes to hindering a precise detection and rapid response to DDoS attacks.

In a DDoS attack response system, user PCs accessing a weak server, which has been hacked by an attacker and infected with a malicious code, may become zombie PCs without their knowledge. In an effort to respond to DDoS attacks generated by these zombie PCs, the DDoS attack is detected by each security system installed by IDC/ISP, an enterprise, or government and notified to a cyber response center such as a national cyber security center, an internet security center, or the like. The cyber response center collects and consistently manages information on the detection and response of the DDoS attacks, and responds to the DDoS attacks in progress. Further, the cyber response center publicly announces a response policy for preventing an increase in damages from the DDoS attack to other IDC/ISP, enterprises, a government, or the like such that the DDoS attack can be prevented in advance. Also, efforts for a national cooperative response have been made to prevent an increase in worldwide damage.

In the response system described above, since the response policy should be established depending on attack information detected by each centralized security system, there is a limit in processing based on the collection and analysis capability.

### SUMMARY OF THE INVENTION

In view of the above, the present invention provides a system and method a system and method for providing a information sharing service for network attacks between a service provider and service users under a reliability-based network environment of Service Oriented Architecture (SOA).

In accordance with a first aspect of the present invention, there is a system for providing an information sharing service for network attacks, the system including:
a service provider configured to collect and analyse information on detection and response policies to network attacks;
a service registry that stores the collected information on the detection and response policies; and
client terminals, each client terminal configured to request the information sharing service and search the service registry for the information on the detection and response policies.

In accordance with a second aspect of the present invention, there is a service provider for providing an information sharing service for network attacks, the service provider including:
a detection unit configured to collect information on detection and response policies of network attacks to a client terminal connected to a network;
a response unit configured to analyse and manage the information on detection and response policies collected by the detection unit; and
a security unit configured to catch and monitor a sign of the network attacks in advance.

In accordance with a third aspect of the present invention, there is a method of providing an information sharing service for network attacks, the method including:
sending, at a service provider, a service request message to an authentication server;
acknowledging an authentication message from the authentication server; and
receiving an authentication result in response to the network service request message from a service registry.

In accordance with a fourth aspect of the present invention, there is a method for providing an information sharing service for network attacks, the method including:
making a request, at a client terminal, to search a service registry for services to be provided from the service registry;
performing an authentication on the request from the client terminal to provide a search result including a plurality of services from the service registry when the request is authenticated to be normal;
selecting, at the client terminal, a service among the services to request a service provider to provide the selected service; and
receiving, at the client terminal, the information sharing service from the service provider in accordance with an authentication result obtained by the service provider.

### BRIEF DESCRIPTION OF THE DRAWINGS

The above and other objects and features of the present invention will become apparent from the following description of embodiments, given in conjunction with the accompanying drawings, in which:

FIG. 1 shows a schematic block diagram of a system for detecting and responding to network attacks in accordance with an embodiment of the present invention;

FIG. 2 illustrates a detailed block diagram of a network service prover shown in FIG. 1;

FIG. 3 shows an example of a message security scheme between the client terminal and the service provider of FIG. 1;

FIG. 4 illsutraters a data model for DDoS Detection Information and Response Policy Message Exchange Format (DPMEF) in accordance with an embodiment of the present invention;

FIGS. 5A and 5B illustrate a class and description of the data model shown in FIG. 4;

FIG. 6 exemplarily shows a classification system and terms of information to be commonly shared for the data model depicted in FIG. 4;

FIGS. 7A and 7B illustrate extensible markup language (XML) data for the DPMEF of the data model shown in FIG. 4;

FIG. 8 is a flowchart illustrating a process performed by the service provider shown in FIG. 1; and

FIG. 9 is a flowchart illustrating a process performed by a client terminal shown in FIG. 1.

### DETAILED DESCRIPTION OF THE EMBODIMENTS

Hereinafter, embodiments of the present invention will be described in detail with reference to the accompanying drawings.

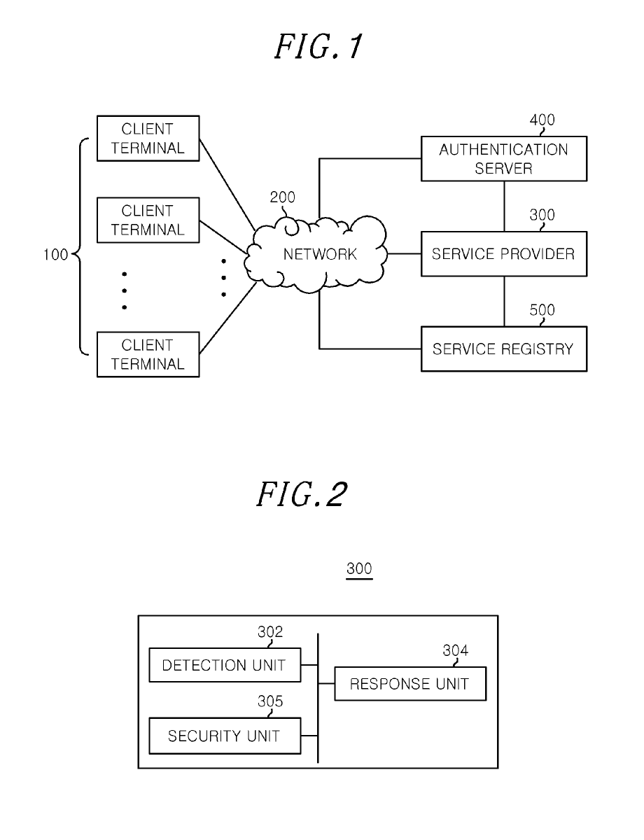

FIG. 1 is a schematic block diagram of a system for network attack management in accordance with an embodiment of the present invention. The system includes a plurality of client terminals 100, a network 200, a service provider 300, an authentication server 400, and a service registry 500.

As shown in FIG. 1, each of the client terminals 100 enjoys an information sharing service in which information about a network attack, e.g., a distributed denial of service (DDoS) attack is shared via a service registry 500 under a reliability-based network environment. More specifically, the client terminal 100 searches the service registry 500 for information on a DDoS attack detection and response policy, and receives the information through a message exchange by a simple object access protocol (SOAP) from the service provider 300. In addition, the client terminal 100 receives a service through various transmission protocols such as hyper text transfer protocol (HTTP), file transfer protocol (FTP), simple mail transfer protocol (SMTP), or the like on the network 200.

The client terminal 100 may include a service user such as an individual or member of an enterprise, a small and medium internet service provider (ISP), or a hosting company that wants to enjoy the information sharing service for network attack detection and response policy. In addition, a cyber response center (not shown) that collects and analyzes information on a service for public purposes to establish a respond policy against network attacks may also be included in one of the client terminals 100.

The network 200 provides a communication connection environment among the client terminals 100, the service provider 300, the authentication server 400, and the service registry 500. The network 200 may be a wideband communication network and a local area network (LAN). The wideband communication network may include a wideband wireless communication network and a wideband wired communication network. The wideband wireless communication network may include a base station and a base station controller, and support both synchronous and asynchronous systems.

In this regard, in case of a synchronous system, the base station will be a base transceiver station (BTS), and the base station controller will be a base station controller (BSC). In case of an asynchronous system, the base station will be a node B and the base station controller will be a radio network controller (RNC). The wideband wireless communication network will include, but is not limited to, a global system for mobile communications (GSM) network instead of a CDMA network, and connection networks of all of mobile communication systems to be implemented in the future.

The wideband wired communication network is, for example, the Internet, and may refer to the world open computer networks providing a TCP/IP protocol and several services at upper layer thereof, for example, HTTP, FTP, SMTP, simple network management protocol (SNMP), network file service (NFS), network information service (NIS), domain name system (DNS) and the like.

The LAN may include a local area wired network and a local area wireless network. The local area wired network may be, for example, a local area network (LAN), and may provide a local area wired communication environment among the client terminal 100, the service provider 300, the authentication server 400, and the service registry 500. The local area wire communication network provides a local area wire communication environment among the client terminal 100, the service provider 300, the authentication server 400, and the service registry 500, and may include a local area wireless communication environment such as Wi-Fi or the like.

The service provider 300 collects the detection and response policy information for a DDoS attack, analyses and manages the collected information, and registers the collected information in the service registry 500. Further, the service provider 300 may catch and monitor a sign of a network attack in advance in order to generate information on the detection and policy to network attacks.

The service provider 300 may provide high level security service depending on the service providing capability. The service provider 300 describes information rearding a type of a service to be provided, in a standardized web service definition language (WSDL), to thus know which operation is supported by a web service and what scheme and which path are used for access to the web service.

The authentication server 400 provides, for example, an XML key management specification (XKMS)/public key infrastructure (PKI)-based authentication service. Encryption and an electronic signature of an XML-based message, web service security (WS-Security), and a security assertion markup language (SAML) should cooperatively operate with PKI in order to effectively share a public key.

The XKMS refers to an XML-based authentication service for protocol regulation with a service interface for registration of a public key, a solution of key information and effectiveness verification thereof. The XKMS may necessary to resolve a complex data structure in using an existing PKI and defects in its implementation. The XKMS may include an XML key information service (KISS) that transmits an actual content of public key information included in an XML electronic signature, and an XML key registration service (KRSS) that requests registration, discard, update, or the like of public key information to a reliable authentication authority.

The service registry 500 complies with a specification for a distributed web-based information registry of a web service so that the client terminal freely access to the service registry. The service registry 500 may be independent to a platform and support an open framework, and allows for a mutual search of the service provider 300 and information sharing through a global registry.

Further, the service registry 500 may include a web service registry in order to activate service sharing by providing web service information for service link and integration. This web service information may include, for example, a service name, service description and service provider, as well as information for calling a web service and receiving service processing results.

FIG. 2 illustrates a detailed block diagram of the service provider 300 shown in FIG. 1. The service provider 300 includes a detection unit 302, a response unit 304, a security unit 306.

The detection unit 302 serves to collect the information on the detection and response policy for a network attack, for example, a DDoS attack.

The response unit 304 serves to analyze and manage the information collected by the detection unit 302 and register the collected information in the service registry 500. The security unit 306 catches and monitors a sign of the DDoS attack in advance.

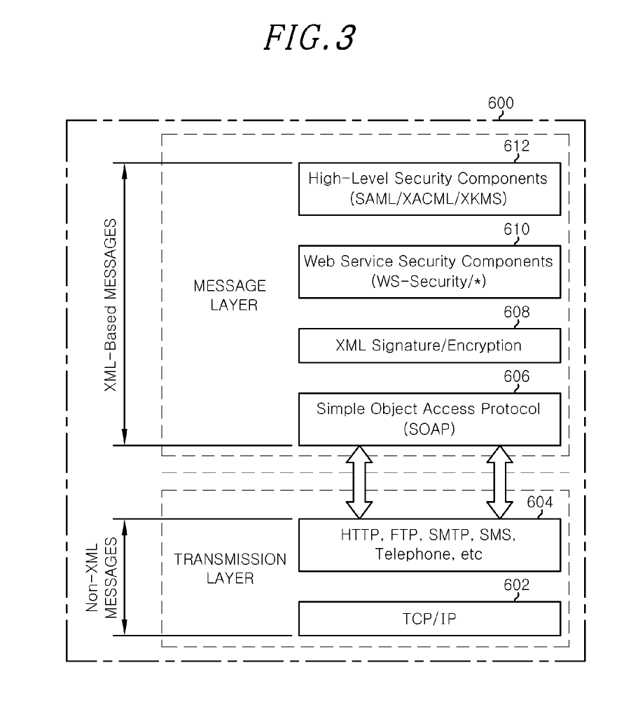

FIG. 3 is a view illustrating a message security system between the client terminal 100 and the service provider 300.

The message security system shown in FIG. 3 includes a hierarchical security system 600 for, for example, XML-based SOAP security messaging.

The XML-based SOAP security system 600 is an XML-based security messaging system for stably exchanging the information on the DDoS attack detection and response policy between a mutual assistant response center and respective security systems. Here, general purposes and security may be supported by using the SOAP protocol having a web-based security function so that information can be exchanged anyplace where the network 200 is connected.

In FIG. 3, the transmission layer includes a transmission protocol area 602 including TCP/IP, and an application protocol area 602 including HTTP/FTP/SMS/Telephone, and the message layer includes an SOAP area 606, an XML signature/encryption area 608, a web service security component 610, and a high-level security component 612.

The transmission layer assures a security of encryption of an overall message, forgery and falsification prevention, client/server authentication, and the like by using SSL/TLS, but the security is not efficient compared with what the message layer performs, due to partial encryption of message, limitation to a user's access range, security problem between intermediate routes.

The SOAP area 606, which is a protocol for a standard method of representing information in an XML at the time of exchange of the information in a distributed environment, and may be independent to a platform or a program language, and a vendor and easy for its implementation and also stable in a firewall. A SOAP message may be represented as one XML document composed of an envelope, a header, and a body. When any client terminal 100 encodes information using the SOAP and then transfers the encoded information to the service provider 300, the service provider 300 decodes the encoded information and allows the decoded information to undertake an appropriate service, thereby obtaining the result, and again performs an SOAP encoding on the result to return the encoded result to the client terminal 100.

The XML-based security technology may include an electronic signature and encryption of an XML document, an XML-based key management, authentication and authority of a service request object, security information exchange for exchanging attribute information, and access control technology to resources.

The XML signature/encryption area 608 provides authentication of electronic document, integrity and non-repudiation functions, and it can be easily integrated with an XML-based application since a signed result has an XML document format. The XML signature/encryption area 608 may provide the confidentiality for the XML document and, therefore, the XML document can be viewed only by an intended user.

For a secure XML-based web service, the standards of the web service security component 610 may be utilized. These standards may be used to have mutually dependent relationships, and main contents of these standards may include description of a specified condition for supporting technologies of multiple security tokens including integrity and confidentiality of end-to-end security, a reliable domain, and encryption.

In an embodiment of the present invention, the description may include a web service security technology (WS-Security) for secure SOAP-based web service message exchange, a web service policy technology (WS-Policy) for generation and exchange of security policy for web service applications, a web service reliability technology (WS-Trust) of allowing for authentication and authority between web service applications pertaining to different security systems, and a communication key management technology (WS-Secure Conversation) between web service applications for generation and sharing of security context between the web service applications.

The XML-based key management within the high level security component 612 defines a protocol for effective management of an open key to solve the problem in which a complex data structure or API should be implemented to use the existing PKI through a web service and to easily use it at lower costs.

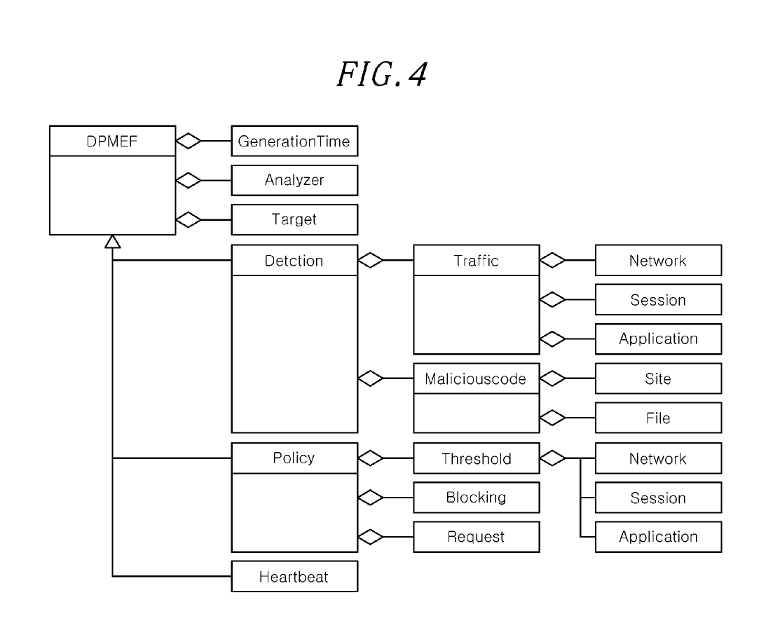

FIG. 4 illsutraters a data model for DDoS Detection Information and Response Policy Message Exchange Format (DPMEF) in accordance with an embodiment of the present invention.

A common message exchange format may be defined based on the data model shown in FIG. 4 and may also be utilized through mutual exchange in several entities such as users, enterprises, institutions, and the like. In order to systematically define the message exchange format, a data model and an actual implementation method based on the data model may be defined.

A data model of detection and response policy information for network attack may be defined using a class diagram of a unified modeling language (UML) that is a design language for an object-oriented methodology. Use of a class diagram of UML may secure scalability and flexibility, and provide standard representation for describing efficiently the relationship between complicated information.

In addition, the data model may be implemented by defining by an XML schema such that scalability and flexibility of an implementation level may be secured. A format of the data model may generally include three types of messages, for example, a detection class including information generated through a detection process for a DDoS attack, a policy class including response policy information for the detection class, and a heartbeat class including an operation state of a system.

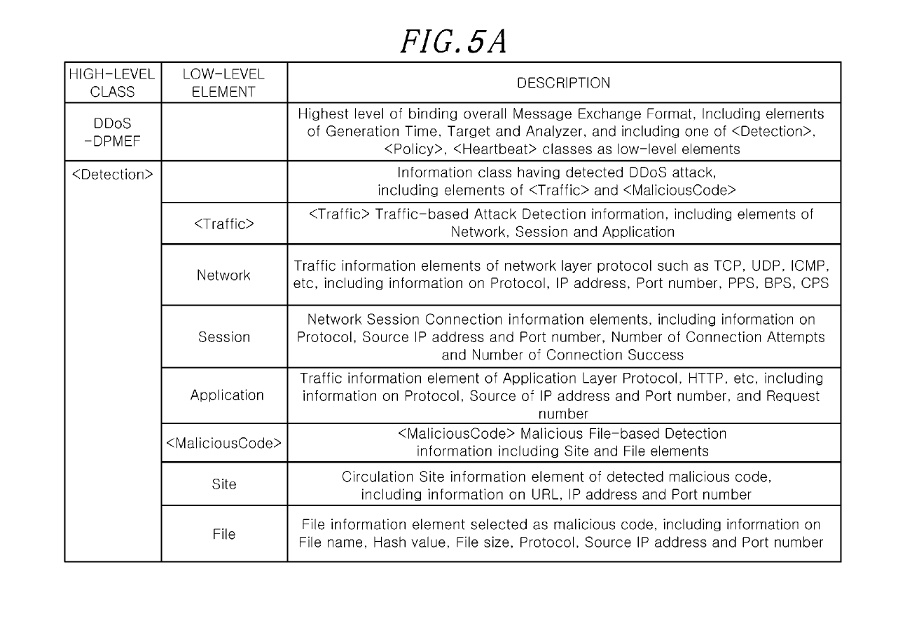

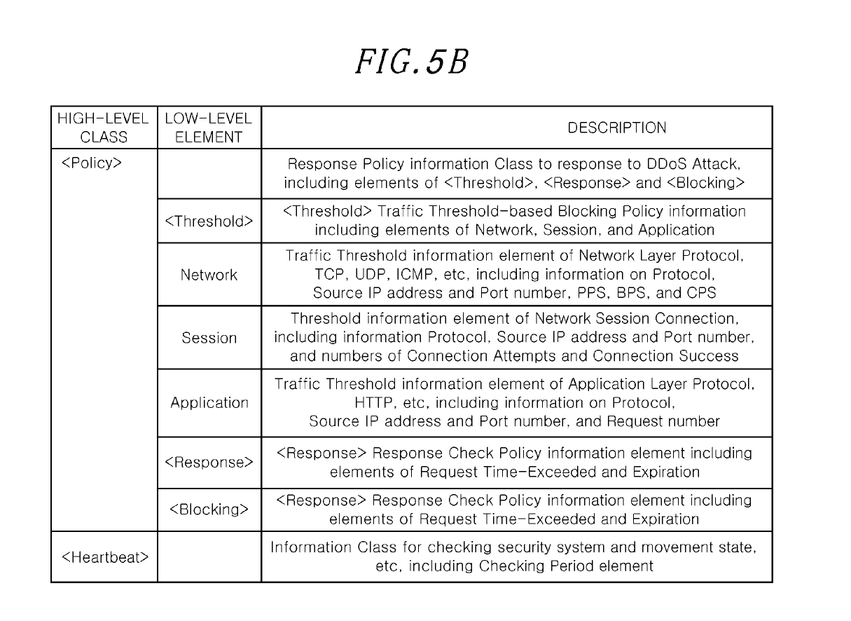

FIGS. 5A and 5B illustrate a class and description of the data model depicted in FIG. 4.

In FIGS. 5A and 5B, the data model may be divided into a high-level class and lower-level elements. In the data model, classes and information thereof may be defined by reflecting various requirements to be appropriate to a service.

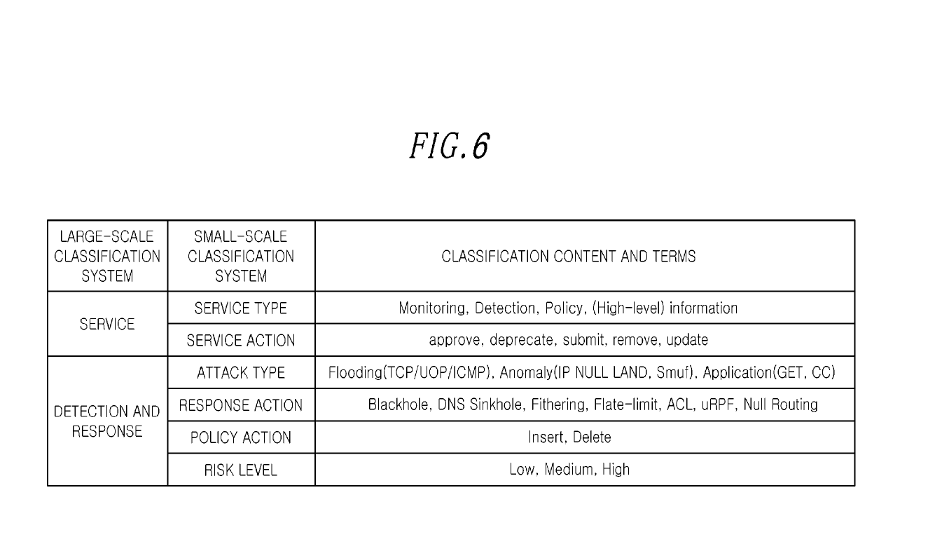

FIG. 6 exemplarily shows a classification system and terms of information to be commonly shared for the data model depicted in FIG. 4.

In FIG. 6, a common classification system and unified terms of information to be mutually shared by participants for the data model shown in FIG. 4 are illustrated. These classification system and consistent terms may prevent confusion in sharing service information and may allow for easy development thereof.

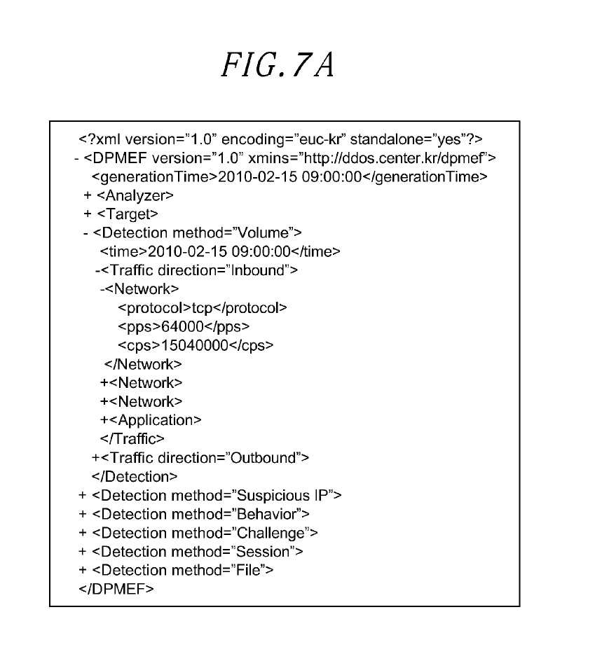

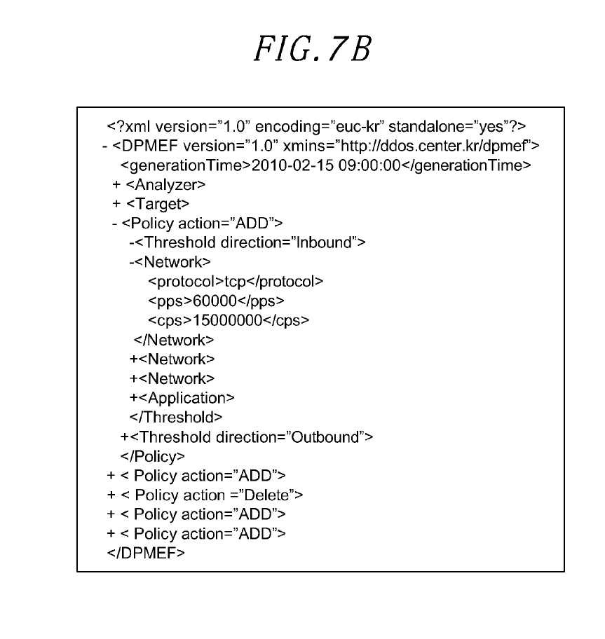

FIGS. 7A and 7B exemplarily illustrate XML data of detected DDoS attacks and response policies to the DDoS attacks of the data model depicted in FIG. 4, and particularly define, by way of an example, DDoS Detection Information and Response Policy Message Exchange Format (DPMEF) having information on FIGS. 5 and 6.

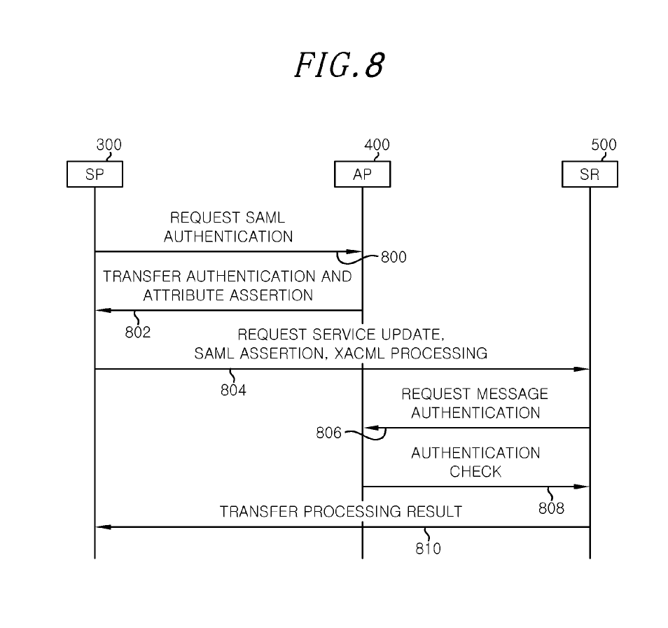

FIG. 8 is a flowchart illustrating a network attack management method, inter alia, a service registration process performed by the service provider 300 in accordance with an embodiment of the present invention. For the service registration process, the service provider 300 needs to rester in the service registry 500 in order to share or service detection information and response information of a DDoS attack, high level information, response policy information, and the like.

As shown in FIG. 8, in step 600, the service provider (hereinafter, referred to ‘SP’) 300 sends a request message to the authentication server (hereinafter, referred to as ‘AS’) 400 in order to obtain authentication, for example, security assertion markup language (SAML) authentication. In response thereto, in step 602, the AS 400 sends an authentication acknowledge and an SAML attribute to the SP 300.

Thereafter, the SP 300 requests the service registry (hereinafter, referred to as ‘SR’) 500 for service update, an SAML Assertion and XACML operation processing in step S604, and the SR 500 requests the AS 400 to authenticate the SAML Assertion in order to authenticate the request from the SP 300 in step S606.

When the SAML Assertion is authenticated in the AS 400, the SR 500 processes the service update and XACML operation in step S608, and sends the processing result to the SP 300 in step S610.

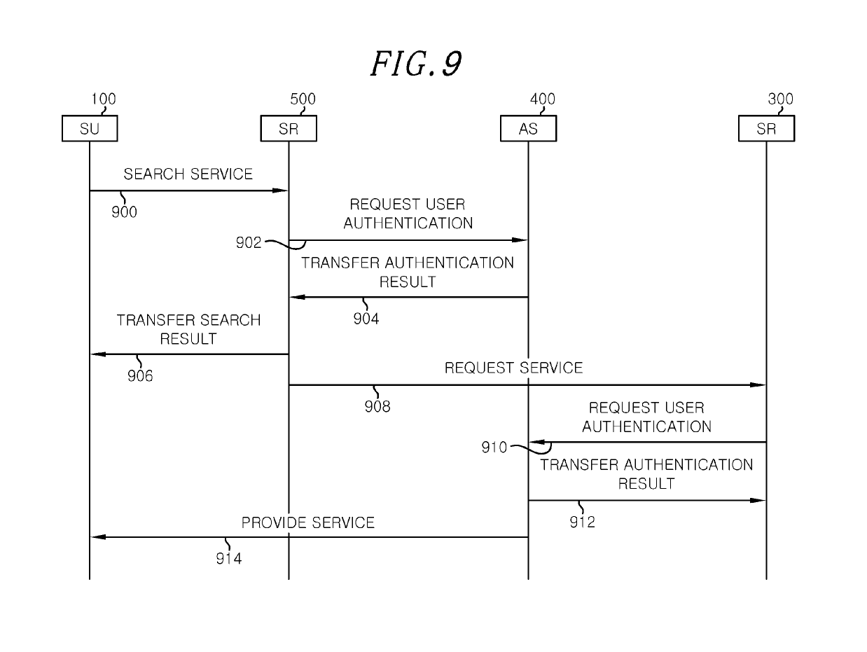

FIG. 9 is a flowchart illustrating a network attack management method in accordance with an embodiment of the present invention, inter alia, by way of an example, a service searching process of a client terminal. In the service searching process, the client searches a service registered in the service registry 500 and enjoys the service from the service provider 300.

First of all, in step 900, a service user of a client terminal 100 (hereinafter, referred to as ‘SU’) makes a request the SR 500 for searching services. In response to the request, in step 902, the SR 500 requests the AS 400 for an authentication of the Su 100.

When the user authentication is completed, the AS 400 sends an authentication result to the SR 500 in step 904.

Upon receipt of the authentication result, if the authentication is verified to be normal, the SR 500 sends a search result, e.g., Services including “monitoring”, “detection”, “policy” and “(high-level) information” shown in FIG. 6, to the SU 100 in step 906.

If, however, the authentication is verified to be abnormal, the SR 500 may send a denial of the service search and a cause of the denial instead of sending a search result to the SU 100.

Next, the SU 100 selects a service among the services including “monitoring”, “detection”, “policy” and “(high- level) information” and requests the SP 300 to enjoy the selected service in step 908.

In step 910, the SP 300 then requests the AS 400 to authenticate the SU 100.

Thereafter, the AS 400 sends the authentication result to the SP 300 in step 912, and when the authentication for the SU 100 is verified, the SP 300 provides the selected service to the SU 100 in step 914.

As described above, in accordance with the embodiments of the present invention, information on the detection and response policy for a network attack, for example, a DDoS attack can be shared and actively utilized within a mutually reliable system. Therefore, limitation in a unilateral analysis and response in an existing centralized system can be supplemented and a service provider can actively participate in a service based on reliability such that a variety of high-level information or the like can be extracted to provide the information as the service. Accordingly, a service user may search an appropriate service for utilization, and expansion to a business model can be possible through close activities with a service provider. In addition, since the existing response system is also maintained, a rapid response to a large scale of situation can be undertaken at the national level and limitation on a centralized analysis, management and response can be resolved. It can be effective to prepare information sharing and a response system between nations by further extending this system and a cyber security information exchange system among nations being promoted recently can be also efficiently established.

While the invention has been shown and described with respect to the particular embodiments, it will be understood by those skilled in the art that various changes and modification may be made without departing from the scope of the present invention as defined in the following claims.

What is claimed is:

1. A system for providing an information sharing service for network attacks, the system comprising:
a service provider configured to collect and analyse information on detection and response policies to network attacks;
a service registry that stores the collected information on the detection and response policies; and
client terminals, each client terminal configured to request the information sharing service and search the service registry for the information on the detection and response policies.

2. The system of claim 1, further comprising:
an authentication server configured to perform an authentication on the client terminal in response to the request of the information sharing service the client terminal and a request for authentication of the client terminal from the service provider.

3. The system of claim 2, wherein the authentication server performs the authentication on the client terminal using a public key infrastructure (PKI)-based authentication service and an XML key management specification (XKMS)-based authentication service.

4. The system of claim 1, wherein the client terminal is further configured to obtain the information on the detection and response policies through message exchange with the service provider.

5. The system of claim 1, wherein the information on the detection and response policies is exchanged between the client terminal and the service provider using an XML-based simple object access protocol (SOAP) security system.

6. The system of claim 5, wherein the XML-based SOAP security system includes a transmission layer and a message layer.

7. The system of claim 6, wherein the transmission layer includes a transmission protocol area and an application protocol area.

8. The system of claim 6, wherein the message layer includes an SOAP area, an XML signature/encryption area, a web service security component, and a high-level security component.

9. The system of claim 1, wherein the network attacks includes a distributed denial of service (DDoS) attack.

10. A service provider for providing an information sharing service for network attacks, the service provider comprising:
a detection unit configured to collect information on detection and response policies of network attacks to a client terminal connected to a network;
a response unit configured to analyse and manage the information on detection and response policies collected by the detection unit; and
a security unit configured to catch and monitor a sign of the network attacks in advance.

11. The service provider of claim 10, wherein the information on detection and response policies is registered in a service registry.

12. The service provider of claim 10, wherein the information of detection and response policies is exchanged between the client terminal and the service provider using an XML-based simple object access protocol (SOAP) security system.

13. The service provider of claim 12, wherein the XML-based SOAP security system includes a transmission layer and a message layer.

14. The service provider of claim 13, wherein the message layer includes:
a SOAP area for encoding and decoding the information on detection and response policies;
an XML signature/encryption area for providing a confidentiality of the information of detection and response policies, the information on detection and response policies being represented an XML document;
a web service security component for an XML-based web service; and
a high-level security component for public key management.

15. The service provider of claim 10, wherein the network attacks includes a distributed denial of service (DDoS) attack.

16. A method for providing an information sharing service for network attacks, the method comprising:
making a request, at a client terminal, to search a service registry for services to be provided from the service registry;
performing an authentication on the request from the client terminal to provide a search result including a plurality of services from the service registry when the request is authenticated to be normal;
selecting, at the client terminal, a service among the services to request a service provider to provide the selected service; and
receiving, at the client terminal, the information sharing service from the service provider in accordance with an authentication result obtained by the service provider.

17. The method of claim 16, wherein said receiving a search result includes:
requesting, at the service registry, the authentication server for the authentication of the client terminal; and
transferring, at the authentication server, the authentication result to the service registry.

18. The method of claim 16, further comprising:
providing, at the service registry, a denial message for the request from the client terminal when the request from the client terminal is authentificated to be abnormal.
